(19) United States
(12) Patent Application Publication
(10) Pub. No.: US 2007/0114695 A1
(43) Pub. Date: May 24, 2007

(54) Production of continuous filament mats

(76) Inventors: Francois Roederer, Chambery (FR); Eric Augier, Naveil (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/582,401

(22) PCT Filed: Dec. 16, 2004
(86) PCT No.: PCT/FR04/50714

§ 371 Date: Jun. 12, 2006

(30) Foreign Application Priority Data
Dec. 17, 2003 (FR) 0314832

(51) Int. Cl. B32B 1/00; D04H 3/05

(52) U.S. Cl. 264/171.13; 425/104; 425/106; 425/377; 156/162

(57) ABSTRACT

An installation and a method of preparing a continuous strand mat, the strands coming from at least one roving thrown onto a conveyor belt. In the method at least one roving package supported on a spindle is paid out via the outside, a rate of the pay-out imposed by a motor acting directly on the roving package so that linear speed of the paid-out roving is constant; then the roving passes through a nozzle, by passing through an entry and then an exit of the nozzle, the nozzle also provided with a transverse injection of at least one fluid mainly directed toward the exit of the nozzle, inducing a tension toward the bottom of the roving, the fluid also dividing the roving; and then the strands forming the roving are thrown in an oscillatory movement onto the conveyor belt.

The present invention relates to the manufacture of mats formed from continuous strands, especially glass strands, and to the manufacture of composites made with such mats.

Products known as “mats” are essentially products used as reinforcement in composites and usually comprise glass strands that are themselves formed from filaments. In general, two types of mat may be distinguished, namely chopped strand mats and continuous strand mats.

Continuous glass strand mats are generally used to produce composite products by molding (in a closed mold), in particular by compression molding or by injection molding. They are usually obtained by continuously distributing and superposing plies of continuous strands by conveyor, each ply being obtained from a bushing by attenuating glass streams into the form of continuous filaments, and then gathering the filaments into strands and by throwing these strands onto the conveyor (with a reciprocal or to-and-fro movement so that the strands cover all or part of the width of the conveyor) which moves transversely to the direction in which the strands are thrown, the cohesion of the strands within the mat generally being provided by a binder deposited on the strands and then oventreated.

An assembly of individual fibers is called a “strand”. A strand generally comprises from 5 to 500 fibers. An assembly of strands is called a “roving”. A roving generally comprises 2 to 50 strands.

It is desired to produce continuous glass strand mats that have properties that vary to a greater or lesser extent, depending on the applications envisioned. When these mats are intended for the production of composites by pultrusion or are intended for electrical applications or for insulation, it is desirable to use flat mats, consisting of strands strongly bonded together and having only small interstices between the strands. However, when these mats are intended for the production of composites by injection molding, it is desirable to use mats that are sufficiently aerated and in particular have or retain sufficient bulk for a given strand weight.

The present invention relates more specifically to an installation for manufacturing such products, both “flat” mats and “aerated” (or bulked) mats.

U.S. Pat. No. 4,368,232 teaches a mat formed from two plies of continuous yarns, one coming from a bushing and the other from a reel or roving package. It will be recalled here that the term “roving package” is a package formed from a roving formed by winding base strands around the axis of the package, said strands being coated to a greater or lesser extent with a size. According to one feature of that patent, the strands coming from the roving package are opened out by a fixed nozzle supplied with compressed air. The nozzle has a larger opening at the top (where the strand enters) than at the bottom (where the strand leaves).

U.S. Pat. No. 3,265,482 discloses a machine for depositing continuous glass strand onto a belt. More precisely, the machine makes it possible to deposit the strand over the entire width of the belt, which is running beneath the machine. The strand comes directly from bushings, so that large quantities of strand can thus be deposited on the belt. Mats as defined above are formed here.

Improvements to this type of manufacture have been proposed, for example by WO 98/10131, which discloses the manufacture of anisotropic mat, i.e. one in which the strands mostly have a preferred orientation. This improves certain mechanical properties. A “to-and-fro” movement of the strand transversely to the conveyor belt allows the strand to be distributed in the preferred orientation.

U.S. Pat. No. 4,158,557 discloses a machine for manufacturing mats from strand coming from at least one bushing or from roving packages. The device for throwing the strand onto the belt “scans” the conveyor belt transversely. The feature of this installation is variation in the speed at which the strand is thrown onto the conveyor belt.

U.S. Pat. Nos. 4,345,927 and 5,051,122 disclose this same type of machine with improvements with the throwing member itself. More precisely, the solution envisioned in U.S. Pat. No. 4,345,927 consists in throwing the strand onto what is called a “rebound” plate owing to its function. Preferably the strand comes from a bushing and is entrained by a set of wheels and then accelerated by a nozzle-type device. Here again, the nozzle and the plate are driven in a transverse movement for distributing the strand over the belt. This movement does not ensure that the strands are distributed uniformly over the belt, the edges receiving less strand than the central part of the belt.

In U.S. Pat. No. 4,948,408, the strands are output directly from a bushing and then pass around a feed roller, which gives the strand a reciprocal movement transverse to the conveyor belt. A “deflector” plate is provided downstream of the strand feed roller, above the conveyor belt. The strand leaving the roller then impinges upon the plate, the surface of which is preferably grooved so as to extend the width of the bundle of base filaments (forming the strand), which drops onto the conveyor belt.

WO 02084005 teaches a device for manufacturing continuous strand mat from strand roving packages. The strands are pulled in order to unwind the packages. However, experience shows that unwinding the roving packages by pulling results very frequently in the strands being broken.

The invention remedies the above mentioned problems and allows continuous strand mats to be manufactured at a high rate, with very little or even no roving breakage. According to the invention, the roving is subjected only to a slight tension, which limits the risk of roving breakage. Within the context of the present invention, roving packages are used. It is therefore possible to implement the invention at a place other than that where the packages are manufactured. The use of a roving package also makes it possible to produce an installation for manufacturing a more compact mat than if the strands were to be used directly beneath a bushing. The present invention relates to the field of mats formed from continuous strands coming from roving packages. The invention makes it possible in particular to carry out short mat production runs more easily, for example producing mats from expensive and/or specific strands. This is because it is possible, for example by combining the installation with one or more roving packages, thereby to manufacture the mat in a limited quantity, with the advantageous characteristics that will be mentioned below, and then to switch to another production based on other roving packages, that is to say other base strands. Such flexibility cannot be achieved when the mat is produced continuously beneath a bushing.

In the case of rovings coming not from bushings but from packages, the rovings are dried before they are wound and the base strands making up the rovings are partly stuck together within the package. On paying out the packages, the base strands are therefore sized to a greater or lesser extent so that there is a problem in this regard. The aim in fact is to throw the base strands onto the conveyor belt in the most uniform manner possible. The major difficulty encountered with this type of production lies in separating the base strands constituting the roving wound around the package. The concepts using a rebound nozzle partly solve this problem. However, the roving package is usually paid out via the inside, which in principle is the simplest method. However, this method introduces a twist into the roving as it leaves the package. This impairs the quality of the mat produced, even if a nozzle is provided for better spreading the roving.

According to the invention, the package is paid out via the outside. In this way, any twisting of the roving is avoided, so that the base strands are less joined together upon leaving the package. Moreover, a suitable subsequent treatment results in complete separation of the base strands thus thrown onto the conveyor belt.

Moreover, treatment of rovings coming from packages generally stops the process as soon as one package has been paid out. Human intervention is then necessary to replace the “empty” package; this takes time and therefore lowers the rate of production. It is therefore desirable to automate the package change, and the present invention proposes a solution to this problem within the aforementioned context, that is to say while still having optimum separation of the base strands.

The invention relates to a method of preparing a continuous strand mat, the strands coming from at least one roving thrown onto a conveyor belt, in which method:
at least one roving package supported on a spindle is paid out via the outside, the rate of said pay-out being imposed by a motor acting directly on the roving package so that the linear speed of the paid-out roving is constant; then
the roving passes through a nozzle, by passing through an entry and then an exit of the nozzle, said nozzle being also provided with a transverse injection of at least one fluid, said fluid being mainly directed toward the exit of the nozzle, inducing a tension toward the bottom of the roving, said fluid also dividing the roving; and then
the strands forming the roving are thrown in an oscillatory movement onto said conveyor belt.

By paying out the package via the outside, thus preventing the roving from twisting, the operation of dividing the roving in the nozzle is carried out more effectively.

The invention also relates to an installation for manufacturing mats formed from continuous strands coming from roving packages and thrown onto a conveyor belt, which comprises:
at least one roving package supported on a spindle;
a means of paying out the roving coming from the package;
at least one nozzle through which the roving passes, by passing via an inlet and then an outlet of the nozzle, said nozzle being also provided with a transverse injection of at least one fluid, said fluid being directed mainly toward the exit of the nozzle, so as to induce a tension in the roving toward the exit; and
a means of throwing the strands forming the roving onto said conveyor belt.

The pay-out means is generally a motor connected to the spindle of the package (where appropriate via a belt or any other appropriate transmission means) and rotating it about its own axis.

After the roving has been paid out, it can then be made to pass over a pulley, the speed of which is measured at any moment, for example by an encoder. The speed of the paid-out roving may thus be measured by the encoder coupled to the pulley driven by the roving. Thanks to the encoder, it is possible to modify, by an automatic means of actuating the package motor, the pay-out speed so that the speed of the roving is constant, independently of the state of unwinding of the package.

In particular, the method can be carried out as follows: after being paid out horizontally, the roving passes over a pulley and is then sent downward. In general, the strand is made to pass through a fixed ring or eyelet located upstream of the down-turn pulley, so that the roving is always correctly positioned relative to the pulley irrespective of the position of the roving on the package at the moment when it leaves it.

In all cases, it is necessary for the roving to be directed downward before passing through the nozzle, which has a substantially vertical position. When this downward direction is taken, the roving passes via the entry and then the exit of the nozzle. The nozzle may be stationary, in which case the roving then passes into a means for throwing it onto a moving belt. The throwing means comprises an oscillating arm intended to throw the strand transversely to the conveyor belt. The throwing means may comprise a tube (through which the roving runs) which oscillates from one side to the other in the manner of a clock balance wheel, in order to throw the roving over the entire width of the receiving belt.

Preferably, the nozzle is carried by the throwing means (the oscillating system). In this case, the entry of the nozzle lies substantially on the oscillation axis.

The injection of at least one fluid into the nozzle is transverse, between the entry and the exit. The fluid leaves the exit more easily than the entry, as the nozzle creates, with respect to the fluid, a larger head loss at the entry than at the exit. Such a difference in head loss may for example be produced by a difference in opening diameter. In general, the fluid may be compressed air. The pressure of the fluid may for example range from 2 to 10 bar and more generally from 3 to 8 bar. The fluid is mainly directed toward the exit, which means that more than half of the flux entering leaves via the exit (generally directed downward). The fluid injected into the nozzle has two functions:
to divide the roving into its constituent strands;
to induce a slight downward tension in the roving, with the consequence that the fluid leaves more easily in the downward direction than the upward direction.

This fluid may be called a “splaying fluid” or “dividing fluid”. This fluid is generally a gas under pressure, such as compressed air. The manufacture of continuous strand mats at high speed, with little or no roving breakage, is made possible by the fact that the roving is subjected only to a slight tension, which is given to it in the nozzle by the dividing fluid.

In addition to the splaying fluid, the nozzle may also be fed with water. This water serves firstly to make the roving heavier, in order to influence its path that it follows when thrown onto the conveyor belt (by increasing the drop angle of the splayed roving). The water may also contribute, as fluid, to generating tension in the roving. The weight of the roving when vertical also contributes to tensioning the roving. In addition to the splaying fluid, a dilute aqueous solution or dispersion containing an active substance may also be fed into the nozzle in order to impregnate the roving, so as to give the mat particular properties such as the formation of a thin surface film, or better compatibility with the material to be reinforced. Thus, according to the invention, the speed of the roving is imposed by the motor that acts directly on the package. The action of the splaying fluid in the nozzle and the weight of the roving do not modify the speed of the roving, but only its tension.

In general, the tension in the roving, between the nozzle and the package, is between 50 and 200 grams and more particularly between 100 and 160 grams. The pressure of the fluid or fluids injected into the nozzle for achieving such a tension is adjusted.

Advantageously, any anomaly in the diameter of the roving paid out is also detected and as soon as an anomaly is detected the roving is cut. The anomalies thus detected may be loops or knots in the roving. These may be detected by a light ray coupled to a photoelectric cell. The light ray is made to pass just beside the roving, so that in the absence of an anomaly the ray is not disrupted. When a knot or loop occurs, this additional thickness will disturb the light ray, which triggers a suitable signal or command, such as for example the actuation of a strand cutter. This strand cutter may be placed above the nozzle along the path of the roving. This strand cutter may be actuated at any time by an operator, or automatically, for example when an anomaly is detected.

The installation may also include a means of detecting when a roving is present, placed downstream of the package and above the nozzle. This detection means may be a light ray coupled to a photoelectric cell. In this case the ray is permanently on the roving so that it is the absence of the strand that causes a signal or command to be triggered.

If a particularly homogeneous and not easily splayable roving has to be treated, the oscillating member may be equipped with a rebound plate linked to the nozzle and located near the exit of the nozzle. The incompletely splayed roving will then impinge on the plate and completely splay it so that the base strands are thrown in a well dispersed and uniform manner onto the belt that is running beneath.

According to one embodiment, the installation includes at least two roving packages, each associated with a nozzle, and said packages are actuated in succession. Two groups of components are then operated alternately so as to pay out in succession a large number of packages coming alternately from these two groups.

According to an additional feature, the end of pay-out of each package is detected.

Thus, any end-of-package or anomaly detection in one of the installations (absence of strand, knot or loop in the roving) can trigger the operation of the second installation.

The constituent material of the base strands is a fiberizable glass, such as E-glass or alkaline-resistant or AR glass, which contains at least 5 mol % ZrO₂. In particular, the use of AR glass results in a continuous strand mat for the effective reinforcement of cementitious matrices.

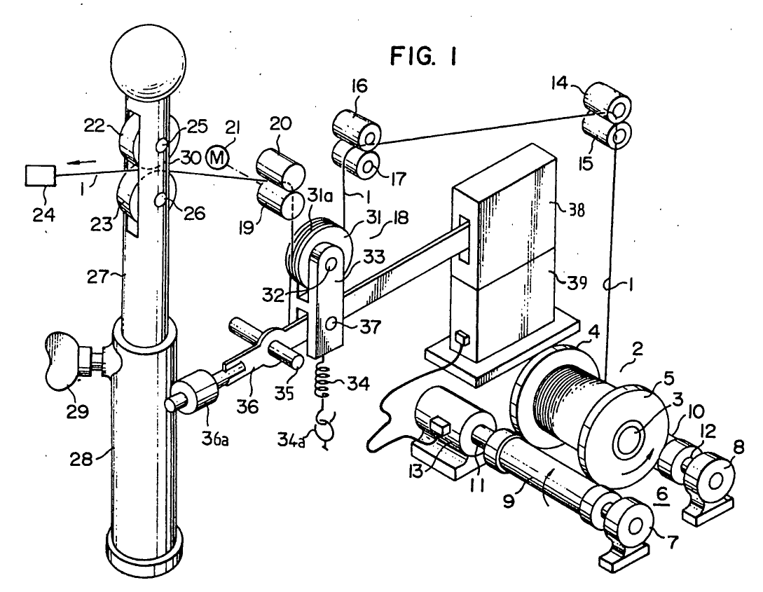

FIG. 1 shows a perspective view of the installation according to the invention.

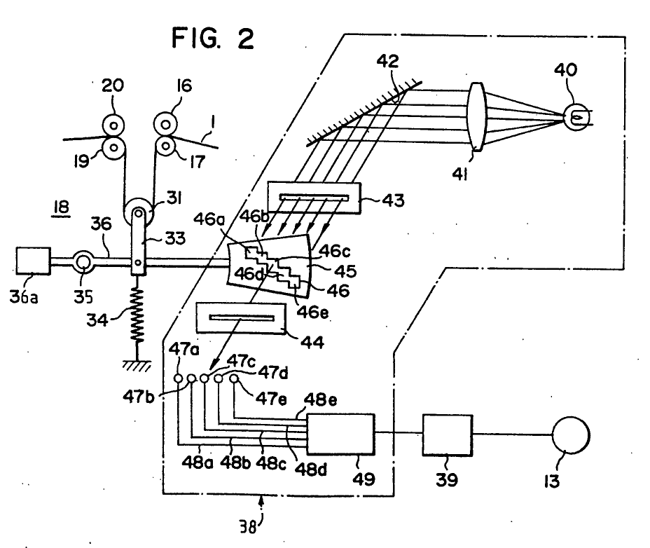

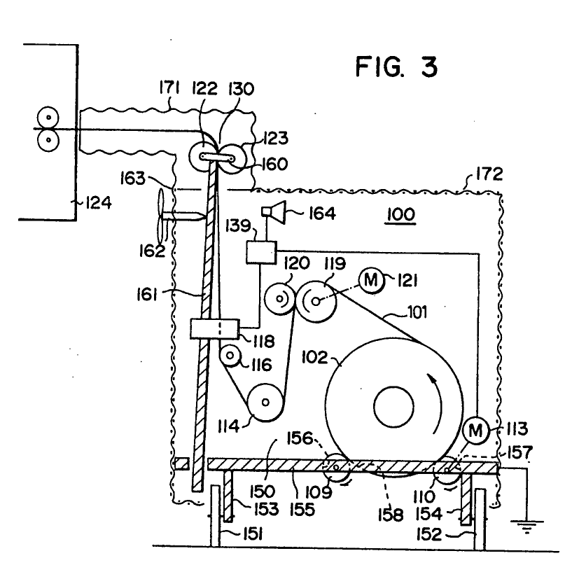

FIG. 2 shows a top view of the installation according to the invention.

The roving package 1 is actuated directly by a motor 19, for example via a cogged belt 20. The package 1 pays out a roving 2 that is not yet divided. The roving passes through the ring (or eyelet) 3, the function of which is to correctly position the roving opposite the pulley 4. The roving passes over this pulley 4 so as to be sent downward. A light ray passes transversely, just beside the roving, at the point 5, thereby making it possible to detect any increase in diameter of the roving (cut-off of the light ray is detected by a photoelectric cell that forces the roving to stop being paid out and actuates the strand cutter 7). The roving then passes through an eyelet 6, the opening of which is equal to that of the nozzle 8. Thus, any strand too thick to pass through the nozzle would be stopped by the eyelet 6. Beneath the eyelet 6 is a strand cutter 7. This strand cutter may be actuated manually at any time or by an automatic mechanism following the detection of too large a diameter at the point 5. A light ray coupled to a photoelectric cell detects the presence or otherwise of the roving at the point 9. The roving then passes through the nozzle 8 via its entry 10, and leaves via its exit 11. The nozzle includes an air injection 12 and a water injection 13. The air injection forces the strand to be divided into its base strands in the nozzle and the roving leaves the nozzle divided into individual strands. The nozzle 8 is fixed substantially at its entry 10 to a plate 14, which is itself connected to a motor 15. The motor gives the nozzle an oscillatory movement from one side to the other, in the manner of the balance wheel of a clock, which makes the roving falling downward cover the width of the belt 16 that is running beneath it. The splayed roving is received on said belt as a continuous strand mat. The plate 14 has another nozzle 17 capable of taking over from the first nozzle when the latter is no longer delivering (the package is empty or there is a problem requiring it to be stopped). It should be imagined that to an entire installation (not shown in order to simplify the figure) equivalent to that just described in the case of the nozzle 8 (package, eyelets, pulley, etc.) corresponds to this nozzle 17. To give an illustration, the linear (constant) speed of the roving 2 of the order of 8 m/s and, depending on the outside diameter of the package 1, the angular speed of the roving leaving the package 1 varies from 500 rpm to 2000 rpm.

When the detector at the point 9 detects the absence of roving, this causes the various elements feeding the roving into the nozzle 8 to stop; simultaneously, this detection causes the other group of elements (mounted in series) parallel to the first group to start, which elements pay out a second package and feed another roving into the other nozzle 17. This alternation represents a considerable gain in production since it makes it possible for the strand to be permanently output onto the belt 16. While one package is being paid out, an operator can operate on an inactive neighboring package—to change it—so as, in background time, to prepare the feed for the second group of elements.

It would be inconceivable to pay out packages one after the other with human intervention between each payout. This is because a 2400 tex roving package, weighing about 24 kg, contains 10,000 meters of roving paid out for example at a speed of 8 m/s. Such a payout takes about 20 minutes. From the industrial standpoint, it is unthinkable to stop production every 20 minutes in order to change a package, with a stoppage time of a few minutes between each payout, with human intervention or even robot intervention. It therefore proves necessary to place various devices in series, in order to form two groups of parallel devices operating alternately.

Without departing from the scope of the invention, a dilute aqueous solution or dispersion containing an active substance may be applied via the feed 13. This solution may then give the mat particular properties, such as the formation of a thin surface film, or better compatibility with the material to be reinforced. FIG. 2 shows a device with two packages (1, 1′) seen from above. The roving passes through the eyelets (3, 3′) and then over the pulleys (4, 4′) which sends it downward. The operator 18 is close to both packages and can rapidly intervene, on the one hand to replace an empty package and on the other hand to act in the event of an anomaly. It is also possible for the packages to be loaded by a robotic device.

1-11. (canceled)

12. A method of preparing a continuous strand mat, the strands coming from at least one roving thrown onto a conveyor belt, the method comprising:
paying-out at least one roving package supported on a spindle via the outside, a rate of the pay-out being imposed by a motor acting directly on the roving package so that the linear speed of the paid-out roving is constant; then
passing the roving through a nozzle, by passing through an entry and then an exit of the nozzle, the nozzle also provided with a transverse injection of at least one fluid, the at least one fluid being mainly directed toward the exit of the nozzle, inducing a tension toward a bottom of the roving, the at least one fluid also dividing the roving; and then
throwing the strands forming the roving in an oscillatory movement onto the conveyor belt.

13. The method as claimed in claim 12, wherein a speed of the roving paid out is measured by an encoder coupled to a pulley driven by the roving package.

14. The method as claimed in claim 12, wherein the nozzle presents the at least one fluid with a higher head loss at the entry than at the exit.

15. The method as claimed in claim 12, wherein the roving includes 2 to 50 strands.

16. The method as claimed in claim 12, wherein the fluid has a pressure of between 2 and 10 bar.

17. The method as claimed in claim 12, wherein the nozzle is also fed with water or with an aqueous solution or dispersion.

18. The method as claimed in claim 12, wherein the tension in the roving between the nozzle and the package is between 50 and 200 grams.

19. An installation for manufacturing mats formed from continuous strands coming from roving packages and thrown onto a conveyor belt, comprising:
at least one roving package supported on a spindle;
means for paying out the roving coming from the package;
at least one nozzle through which the roving passes, by passing via an inlet and then an outlet of the nozzle, the nozzle also provided with a transverse injection of at least one fluid, the at least one fluid being directed mainly toward the exit of the nozzle, so as to induce a tension in the roving toward the exit; and
means for throwing the strands forming the roving onto the conveyor belt.

20. The installation as claimed in claim 19, wherein a pulley is driven by the paid-out roving, and an encoder is coupled to the pulley measuring the speed of the roving.

21. The installation as claimed in claim 19, wherein the nozzle is supported by the means for throwing.

22. The installation as claimed in claim 19, including at least two roving packages, each associated with a nozzle.
